(19) United States
(12) Patent Application Publication
(10) Pub. No.: US 2016/0302986 A1
(43) Pub. Date: Oct. 20, 2016

(54) ROBOTIC MOBILE MODIFIABLE BED

(71) Applicants: Petra HALADOVA, Horni Bludovice (CZ); MORAVSKY VYZKUM, s.r.o., Ostrava (CZ)

(72) Inventors: Petra HALADOVA, Horni Bludovice (CZ); Pavel HALADA, Havirov - Mesto (CZ)

(21) Appl. No.: 15/034,868

(22) PCT Filed: Nov. 15, 2013
(86) PCT No.: PCT/CZ2013/000150

§ 371 Date: Jun. 19, 2016

(30) Foreign Application Priority Data
Nov. 7, 2013 (CZ) PV 2013-859

(51) Int. Cl. A61G 7/16; A61G 7/015

(52) U.S. Cl. CPC A61G 7/16; A61G 7/015

(57) ABSTRACT

The robotic mobile modifiable bed (1) consists of the mobile omnidirectional chassis (2) and modifiable area (4) equipped with a convertible system (3) that allows its controlled converting, while the mobile omnidirectional chassis (2) contains a central frame (5) and in its upper part there are four linear chassis conductors (6) and on each couple of these linear chassis conductors (6) in front-back direction there is suspended an extensible frame (7), while in each of them there is laid through silent-blocks a fixed axle (9), consisting se of a connecting part (10) and omnidirectional wheels (12) while in the connecting part (10) there are the drives (11) of the omnidirectional wheels (12), while the front and back extensible frames (7) are connected by a linear drive (13) of the chassis extension, while in the extensible frames (7) there are located the control units (15) of the wheel rotational drives (11) and furthermore in the longitudinal axis of the central frame (5), in the lower part there is the place for a battery charger (16), and along sides there are the batteries (17), while the mobile omnidirectional chassis (2) is equipped with circumferential bumper features (18), while the mobile omnidirectional chassis (2) is equipped longitudinally and axially with a divided central cover (19), while in axial and lower part of the central frame (5) there is the connection area (21) with features for linking to a necessary type of the utility extension of the mobile omnidirectional chassis (2), while the modifiable area (4) consists of basic features of frame subassembly

### THE TECHNOLOGY AREA

The invention relates to a transport universal robotic convertible device designed especially for immobile persons, with the function of wide range of convertible positions, easy maneuverability, and high variability in the possibilities of control.

### CURRENT STATE OF THE TECHNOLOGY

Currently there is a number of transport and convertible devices developed especially for immobile and motion handicapped persons. However, the overall style and construction of these systems is only purpose-built, with a minimal universality. Usually they are either wheelchairs without the option of convertibility or devices that allow setting to the horizontal plain in order to create an area for lying, but only on a pre-selected place within the circumferential frame, making up the partial surfaces of the area for lying.

The following invention applications are examples of those that are closest to the suggested solution: US 2012/016093 A1 of Jun. 5, 2012, EP 2 581 072 A1 of Apr. 17, 2013, EP 2 583 650 A1 of Apr. 24, 2013, EP 2 583 651 A1 of Apr. 24, 2013.

The above mentioned inventions are build on the principle that the chair runs from the basic structure of the bed. These collapsible structures of the bed-chair do not allow for height adjustability of the bed and chair system and do not allow achieving the standard size parameters of a bed.

In the variant that a part separates from the basic structure of the bed and runs as a wheelchair, this basic structure of the bed stays in the space as an obstacle. Another disadvantage is a solution of the area for lying itself that is divided right in the middle along its all length. Therefore, a mattress or upholstery is divided in a place where the user always lies.

The suggested solutions are not controlled by robotic features so that when changing from the lying position to sitting position or vice versa the perch between the front and back axle would be changed automatically, resulting in the automatic reduction or extension of the mobile base of the chair, adjusting to the current requirements for the device stability.

The width of current devices—wheelchairs—is generally constant, therefore it is not possible to apply the option of width modifiability so that it would be possible to extend the width of the area for lying for the lying position, and narrow it operatively for the sitting position in order to allow both for comfortable lying and passage through more narrow spaces such as doors.

### THE ESSENCE OF THE INVENTION

The above mentioned disadvantages are to a large degree solved by the robotic mobile modifiable bed with mobile omnidirectional chassis containing a central frame and in its upper part there are four linear chassis conductors and on each couple of these linear chassis conductors in front-back direction there is suspended an extensible frame, while in each of them there is laid through silent-blocks a fixed axle, consisting se of a connecting part and omnidirectional wheels, while in the connecting part there are the drives of the omnidirectional wheels, while the front and back extensible frames are connected by a linear drive of the chassis extension and the end position of both extensible frames are limited by extensible frame stops, while in the extensible frames there are located the control units of the wheel rotational drives and furthermore in the longitudinal axis of the central frame, in the lower part there is the place for a battery charger, and along sides there are the batteries, while the mobile omnidirectional chassis is equipped with circumferential bumper features, while the circumferential bumper features are firmly attached to the central frame and the front-back circumferential bumper features are part of the extensible frames, while the mobile omnidirectional chassis is equipped longitudinally and axially with a divided central cover attached to the central frame and front covers attached in the extensible frames, while in axial and lower part of the central frame there is the connection area with features for linking to a necessary type of the utility extension of the mobile omnidirectional chassis.

The above mentioned disadvantages are to a large degree solved also by the robotic mobile modifiable bed consisting of a mobile omnidirectional chassis and modifiable area equipped with a convertible system that allows its controlled converting, and its fundament is in that the modifiable area consists of basic features of frame sub-assembly transverse and at the same time refract lines, that is head line, back line, gluteal line, femoral line, calf line and plantar line where each of the lines consists of the central part and two sides, while all the central parts make in the longitudinal direction refract central line and all the sides make two longitudinal side lines, while the gluteal line consists only of the central part, while the mutually connected central parts and sides are axially and swingingly connected, while the positioning of the opposite sides and blocking the sides in the plane position is controlled by the drive of the sides, while positioning of each of the edge of the central line is done by linear drives of the central line, while with the gluteal line, in the main central axis of the modifiable area, there is firmly connected the area attachment that is through the linear conductors of the extension connected with the pillar attachment, while between the modifiable area and mobile omnidirectional chassis there is an interface, whose connecting features fall into the connecting area of the mobile omnidirectional chassis.

Furthermore, it is advantageous to have the central parts and sides axially and swingingly connected by the staggered suspensions, while the staggered suspensions are firmly connected with the respective parts and the opposite parts are axially tied by the suspension axis.

Furthermore, it is advantageous to have as part of the sides the sides of the femoral line that in the upper position serve also as an arm rest.

Furthermore, it is advantageous to have the positioning of the opposite sides controlled always by one side drive through strings of the linear drive via the divider roll, while the string of the linear drive runs in the eccentric groove of the side and it is anchored in the side by its ending, while the sides are in the plane position always blocked by one or two conic connections that are controlled also by the respective side drive, while the conic connection is laid near the suspension axis, while in one of the opposite staggered suspensions there is a conic sleeve into which falls the extensible cone laid in the sliding sleeves of the second opposite staggered suspension and it is pushed by a spring of the cone, while the extensible cone is connected by a reject rod controlled by a link over a rock arm where this link includes a guide bar and it is conducted in a guide body that is connected through the arm with a motion sleeve, while another part of the side drive is a reversible motion screw laid in the central part in the fixation block in the radiaxial bearing and radial bearing where the reversible motion screw is over one-grade transmission located between the bearings and driven by rotational drive, attached by flange also in the fixation block, while in each of the opposite motion threads there is screwed on a motion nut with a respective thread, while each of them is laid in the motion sleeve, where each motion sleeve is on the side firmly connected with the form slider laid in a guide, and the front part of the motion sleeve is firmly connected with the guide sleeve, ended with a firmly connected shoulder, while on this assembly there is placed the guide sleeve with an end double shoulder, while between one and the other shoulder there is a pull spring laid in, where the second shoulder of the guide sleeve with the end double shoulder is used to support the screw shoulder with a set screw screwed into it, while axially in this screw there is the end of the linear drive string, secured by two pressing screws, while the reversible motion of the sides is secured by springs through the side strings where the spring is always laid in a guide pipe and pressed by a guide head with shoulder that supports a adjusting nut and set screw in which there is axially laid end of the side string and fixed by pressing screws.

Furthermore, it is advantageous to have the pillar attachment firmly tying the heads of the extensible telescopic pillars where in the pillar attachment there is the rotational drive of area attachment in form filling into the shape ridge, that is part of the area attachment, while on the opposite side of the extensible telescopic pillars there are their feet including connecting components and serving for connection with the connecting area of the mobile omnidirectional chassis.

Furthermore, it is advantageous to have the surface of all the parts of the modifiable area covered by upholstery, while the upholstery is reinforced on the outer edges with a decline to the central part of the area for lying, furthermore even the central parts are declined in the end region of the head line towards inward of the modifiable area.

Furthermore, it is advantageous to have a socked holder of the control located on the modifiable area.

Furthermore, it is advantageous to have the control located in the area of the arm rest on the side of the femoral line.

Furthermore, it is advantageous to have the control located on the tipping board located on the back side of the head line central part.

It is a universal robotic device usable both for transport and for therapeutic and remedial processes on immobile and motion handicapped persons. The structure is adapted so that in variant positions it suits the needs of a handicapped user for his lying position or using the robotic control of the individual lines of the modifiable area and the structural features into the sitting position.

A major advantage of the system is its universality with the option to use it for immobile persons, while it has a convertible system allowing a quick change of the sitting-lying position. The complex electronic control enables full automation of the changes between the sitting position and lying position within a few seconds and continually all the positions between the alternative of sitting and lying. It allows a wide range of possible positions of modifiable area that enables a wide range of positions within the transition between two uttermost positions, i.e. the sitting position when the robotic mobile modifiable bed has a shape of a chair and the horizontal position is allowed by its transverse and longitudinal division.

At the same time the device can be used also for performing effective therapeutic and remedial processes, with setting the angular motion of the individual modules, including setting the speeds of this motion, in the planned sequences, continually. The great variability in the area of control is also advantageous—the options of manual and remote control, the option of using the system of automated motions

### THE ADVANTAGES OF THE DEVICE

1) Functionally it covers two systems, in competitive products they are modifiable chair and a docking station, into one compact unit with the variable size parameters (it eliminates the need to use a docking station that is big and difficult to manipulate with).
2) It allows height positioning of the user with a big range, assuring comfort for the user.
   The height positioning of the upper part of the robotic and modifiable bed is realized using extensible telescopic pillars with electric drives, allowing positioning of both the area for lying in case of bed position and the area for sitting in case of chair position. This parameter of height changes allows for easier getting on and off of the user in both alternative positions.
3) It does not have any division in the longitudinal central axis, moreover the ratio of widths between the modification of chair—horizontal area for lying is big, i.e. the chair can go even through a door but the horizontal area for lying is very comfortable in its width. (some devices that are currently marketed have the area for lying divided right in its center along its all length. Therefore, a mattress or upholstery is divided in a place where the user always lies. It is not the case of the robotic mobile and modifiable bed as the main area for lying is divided only transversely into the required number of segments. Only the sides are divided longitudinally. Even though this is only one device—without any docking station—the overall size of the area for lying are very comfortable).
4) The advantage is that for improving the stability of the horizontal lying modifiable area the option to enlarge the axis perch by their extension (this means that the required stability is secured even without the docking station).
5) With advantage it uses omnidirectional wheels, thus reducing the number of drives without any negative impacts on the maneuverability (no need for drives for rotating the wheels).

The bed in horizontal position is characterized by a central line of module and side modules, in connection with the robotic features and drives so that the area serves for comfortable lying, in case that the control system calls the position of the bed device into the sitting line of the chair, the side modules get tilted into the required positions, the side modules adjacent to the central sitting part of the bed get tilted into the vertical position and create arm rests, the back and foot module is then angularly set into an optimal position of the chair sitting line, the robotically controlled perch of the front and back axle is decreased into the optimal size suitable for moving the chair indoor and using the control joystick or remote or memory control the device is then moving in the space as needed by the user using the guidance system for narrow spaces.

### OVERVIEW OF FIGURES ON THE DRAWINGS

The attached sheets contain figures and legend.

The figure for annotation shows the overall axonometric view of the robotic mobile modifiable bed without covering the chassis, showing some details in the view from below. In the right upper corner there is the overall view of the modifiable area in the shape of a chair.

FIG. 1 the overall axonometric view of the robotic mobile modifiable bed without covering the chassis, showing some details in the view from below. In the right upper corner there is the overall view of the modifiable area in the shape of a chair.

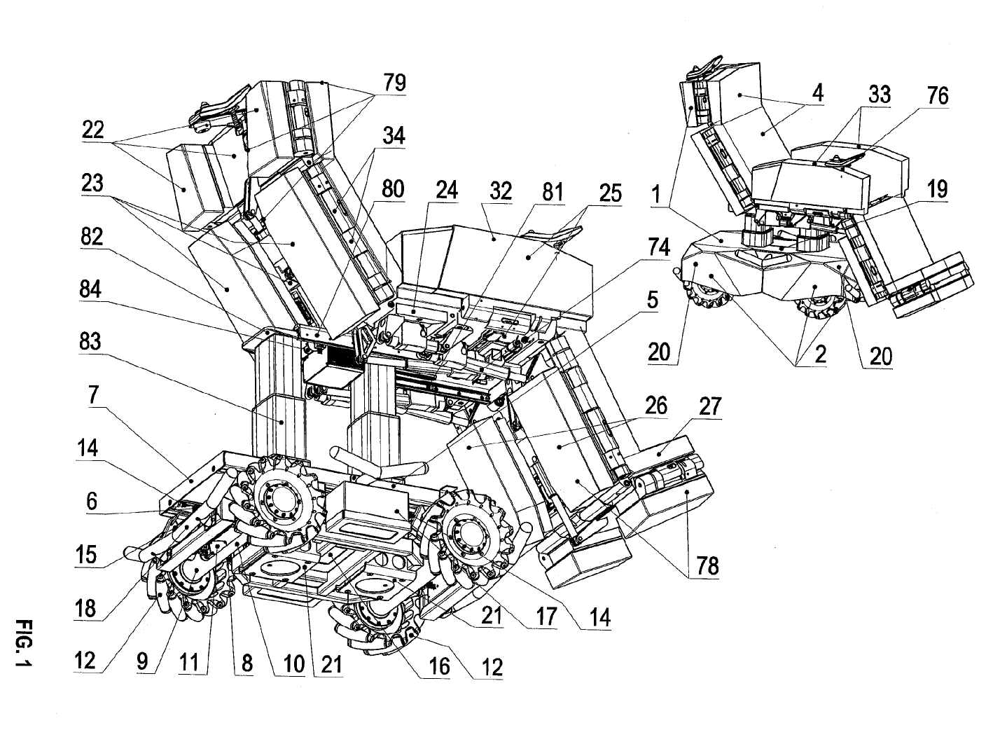

FIG. 2 the overall axonometric view of the robotic mobile modifiable bed in the shape of horizontal area for lying, without covering the chassis, showing some details especially of the convertible system including the chassis. In the left bottom corner there is the overall view of the modifiable area in the shape of horizontal area for lying in the lowest stabilized position with the biggest axle perch.

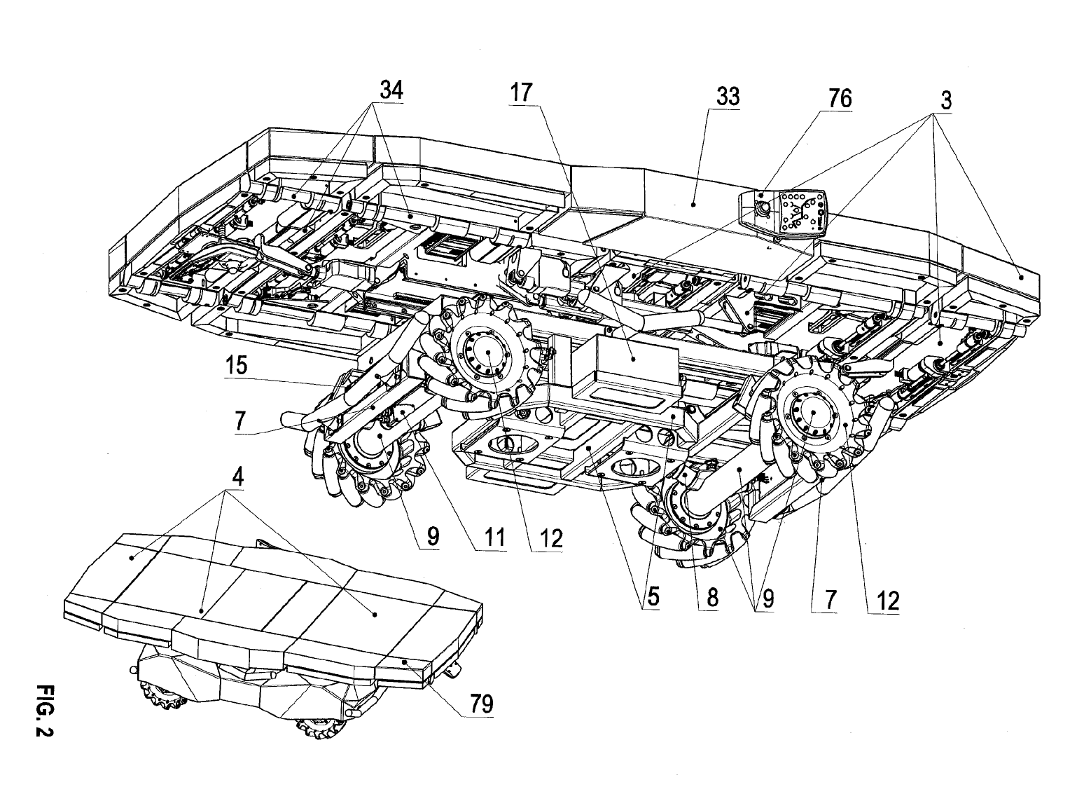

FIG. 3 detailed axonometric views of the chassis without covering with the circumferential bumper features and the least axle perch.

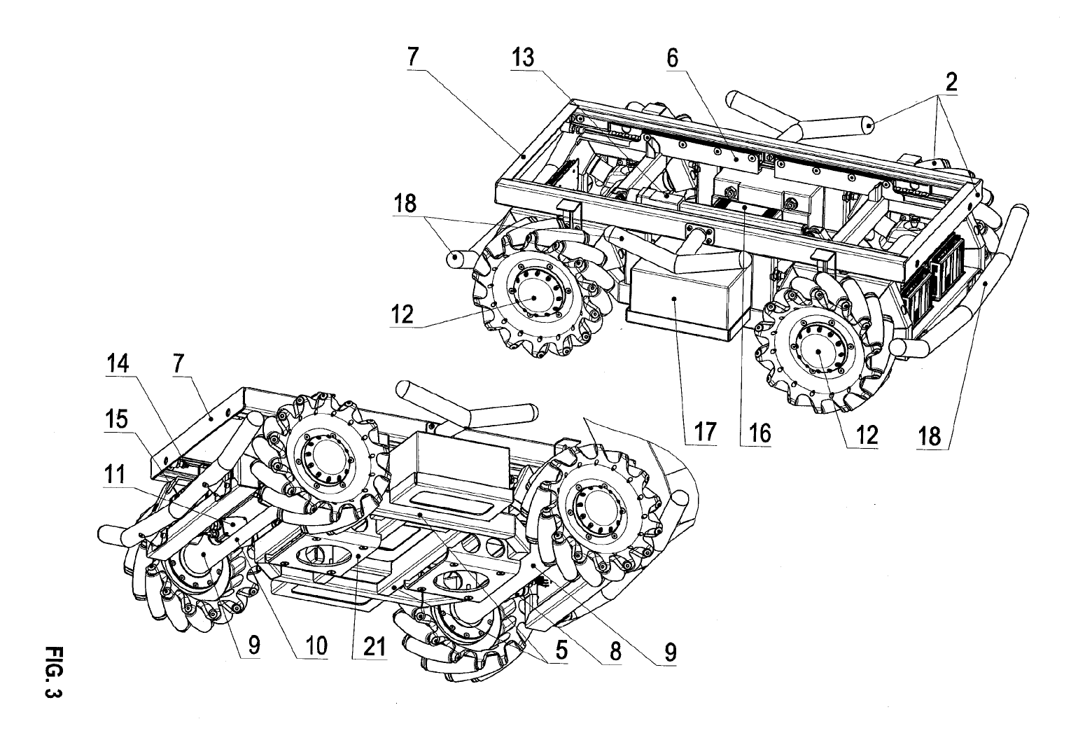

FIG. 4 the overall view of the robotic mobile modifiable bed—side view. The robotic mobile modifiable bed is in the shape of horizontal area for lying in the lowest stabilized position with the biggest axle perch.

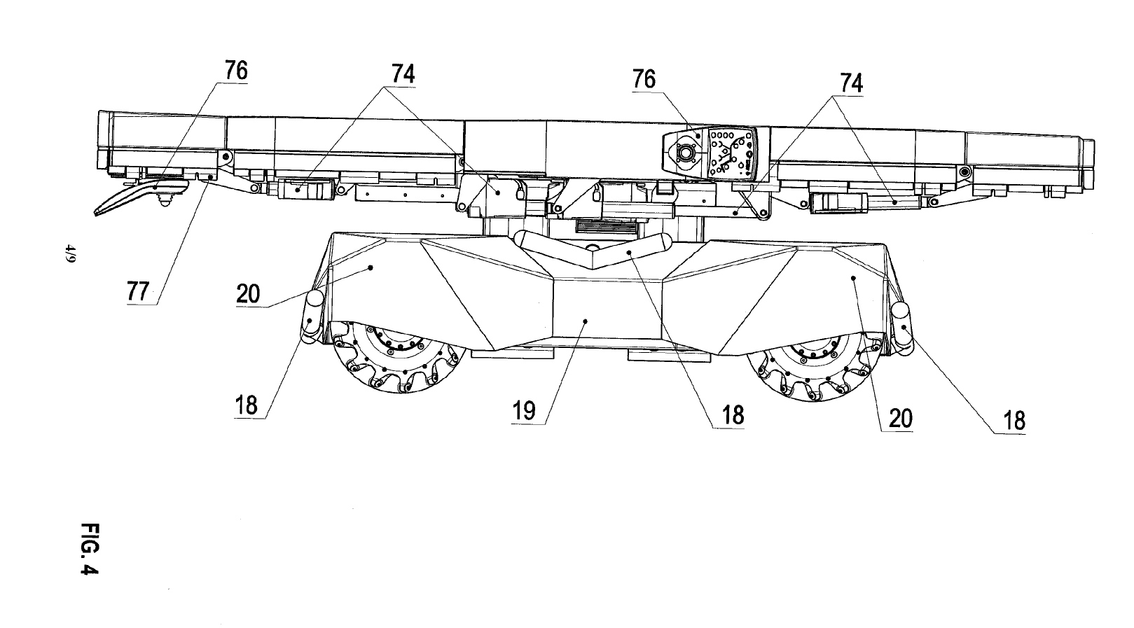

FIG. 5 the overall axonometric view of the robotic mobile modifiable bed with covering the chassis when the modifiable area is in the shape of chair and the control is located in the arm rest. In the corner there is a detailed view of the control located on the swinging tipping board.

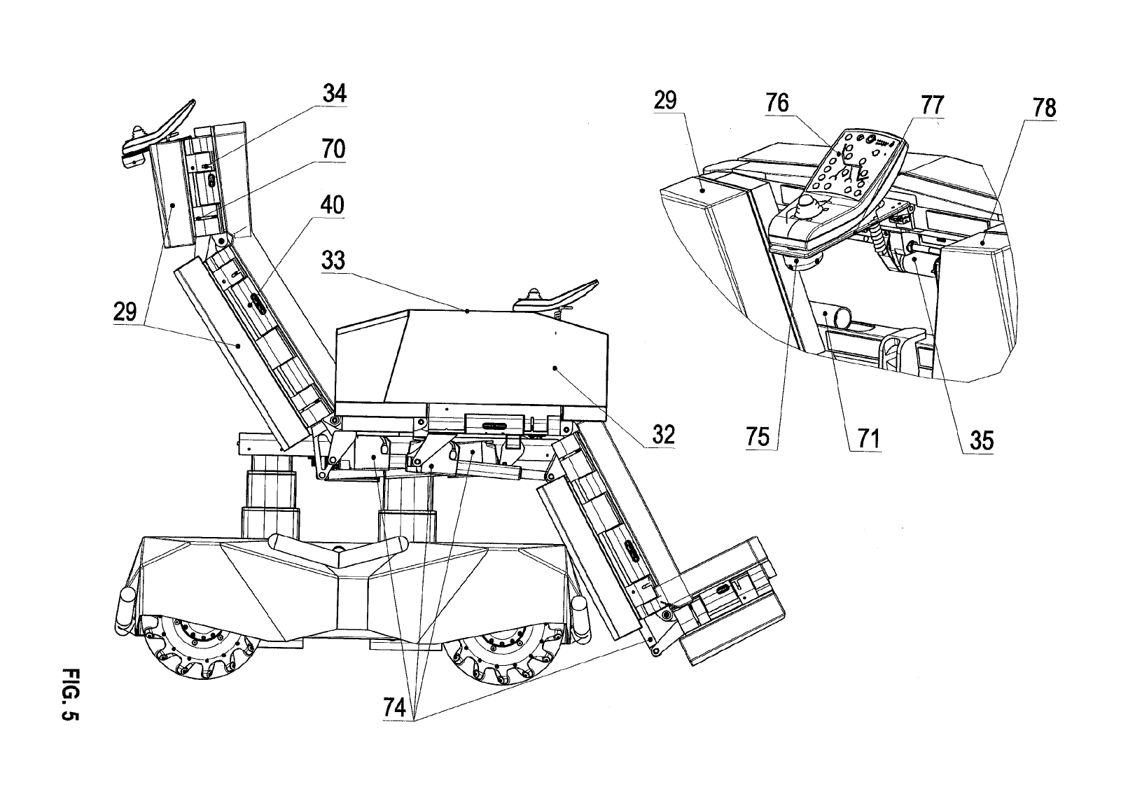

FIG. 6 the overall axonometric views of the robotic mobile modifiable bed. The robotic mobile modifiable bed is in the shape of horizontal area for lying in the lowest stabilized position with the biggest axle perch.

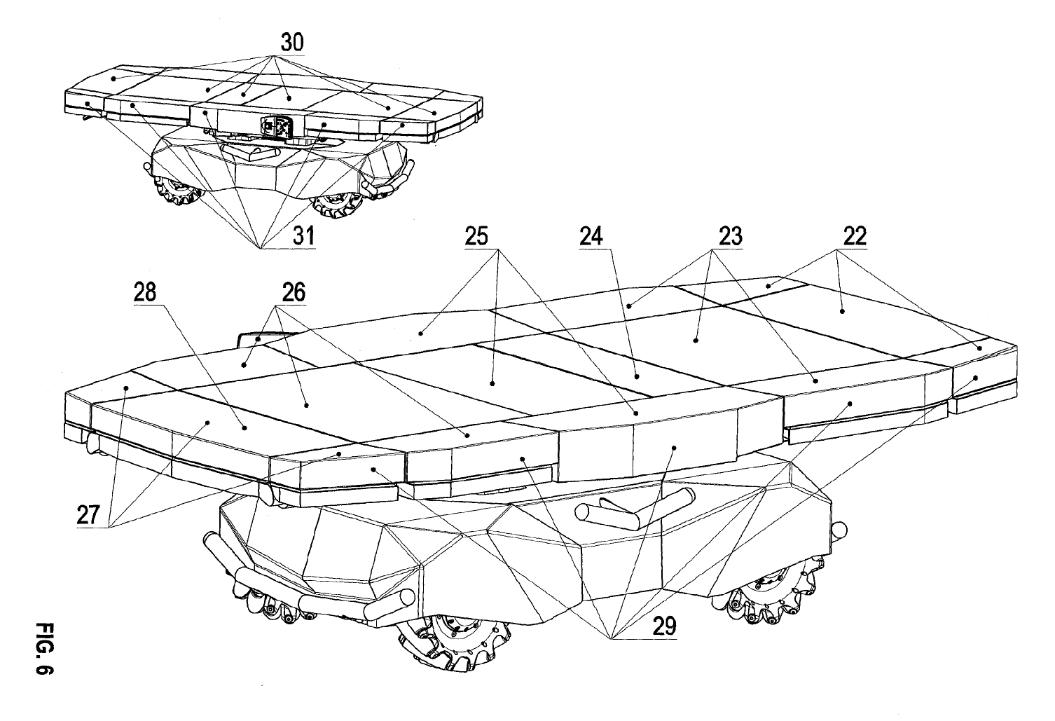

FIG. 7 the axonometric view of the convertible system of the robotic mobile and modifiable bed with extensible pillars ended with feet for connection with the mobile omnidirectional chassis. The detail shows the drive of the drive of the modifiable area extension including the connection of the extensible telescopic pillars.

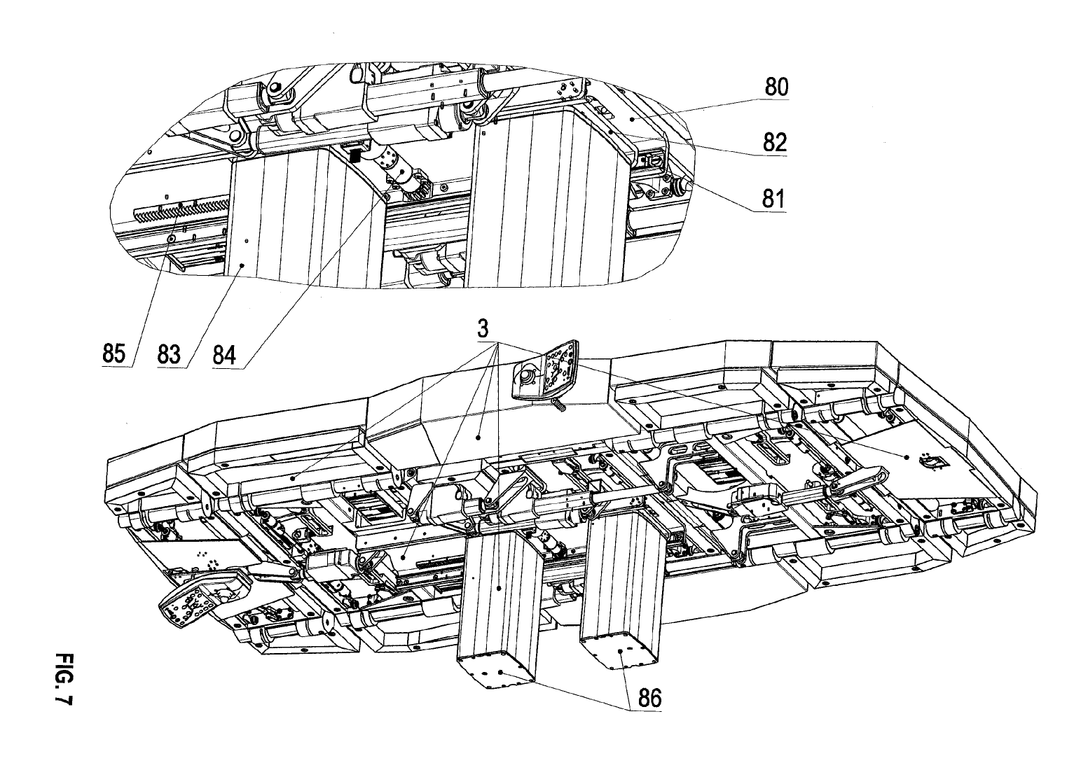

FIG. 8 the detailed sectional view of the side linear drive with the double reversible screw and a detail of a conic connection.

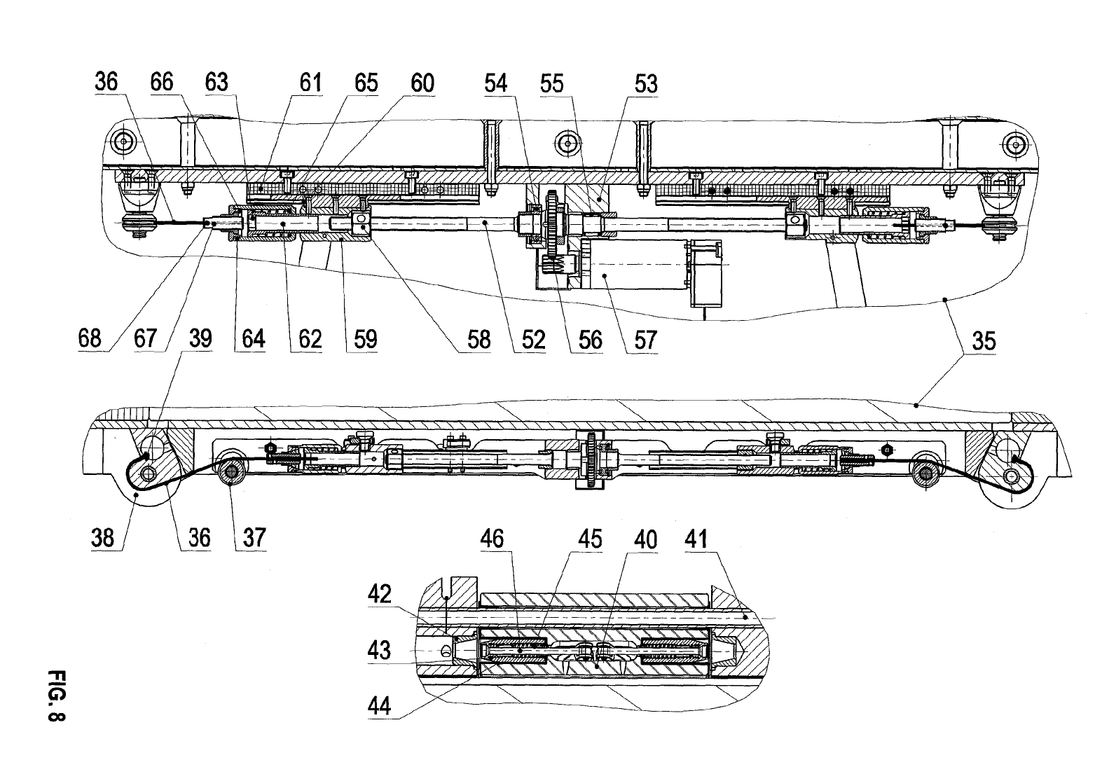

FIG. 9 the axonometric view of the side linear drive with the conic connection, in the sectional view there is location of the reversible spring of the sides in the guide pipe with the tractive string of the side.

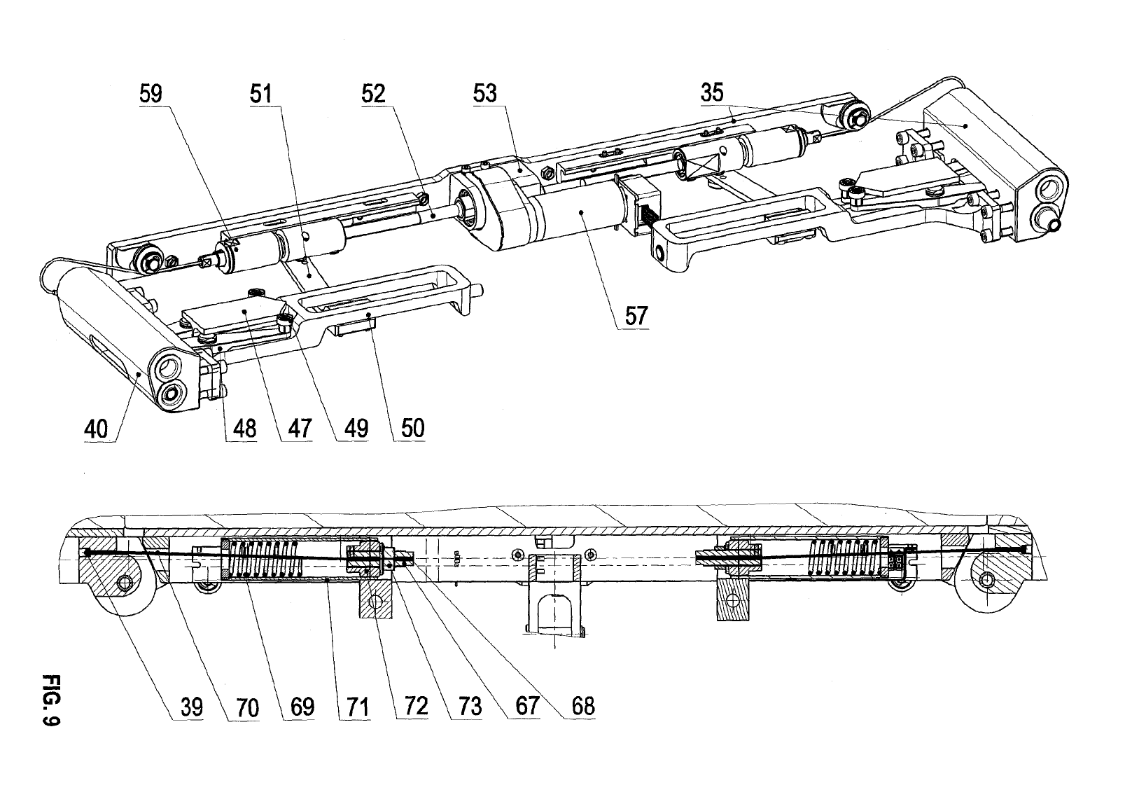

### AN EXAMPLE OF THE INVENTION VARIANT

The robotic mobile modifiable bed 1 allowing the controlled adjusting of the convertible system 3, modifiable area 4 with the option to convert the modifiable area 4 into a plane area, consists of the mobile omnidirectional chassis 2 on which the modifiable area is located 4.

The basic subassembly of the mobile omnidirectional chassis 2 is the central frame 5 and in its upper part there are four linear chassis conductors 6. On each couple of these linear chassis conductors 6 in front-back direction there is suspended an extensible frame 7, while in each of them there is laid through silent-blocks 8 a fixed axle 9, consisting se of a connecting part 10 and omnidirectional wheels 12 while in the connecting part 10 there are the rotary drives 11 of the omnidirectional wheels 12.

Front and back extensible frames 7 are connected by a linear drive 13 of the chassis extension and the end position of both extensible frames 7 are limited by extensible frame rubber stops 14. In the extensible frames 7 there are located the control units 15 of the wheel rotational drives 11. In the longitudinal axis of the central frame 5, in the lower part there is the place for a battery charger 16, and along sides there are the batteries 17.

The mobile omnidirectional chassis 2 is equipped with circumferential bumper features 18, while the circumferential bumper features 18 are firmly attached to the central frame 5 and the front-back circumferential bumper features 18 are part of the extensible frames 7. Underneath there is longitudinally and axially divided central cover 19 attached to the central frame 5 and two parts of the front cover 20 attached in the extensible frames 7. In axial and lower part of the central frame 5 there is the connection area 21 with features for connection to a suitable attachment, such as a modifiable area 4.

Another large subassembly is a modifiable area 4 consisting of the following basic features of frame sub-assembly transverse and at the same time refract lines: head line 22, back line 23, gluteal line 24, femoral line 25, calf line 26 and plantar line 27.

Each of these lines except the gluteal line 24 consists of the central part 28 and two sides 29, while all the central parts 28 make in the longitudinal direction refract central line 30 and all the sides 29 make two longitudinal side lines 31. The gluteal line 24 consists only of the central part 28.

The mutually connected central parts 28 and sides 29 are axially and swingingly connected by the staggered suspensions 34, while the staggered suspensions 34 are firmly connected with the respective parts and the opposite parts are axially tied by the suspension axis 41. The sides of the femoral line 32 in the upper position serve also as an arm rest 33.

The positioning of the opposite sides 29 is controlled always by one side linear drive 35 through strings of the linear drive 36 via the divider roll 37, while the string of the linear drive runs in the eccentric groove 38 of the side 29 and it is anchored in the side 29 by its ending 39. The sides 29 of the modifiable area 4 are in the plane position always blocked by one or two conic connections 40 that are controlled also by the respective side linear drive 35.

The conic connection 40 is laid near the suspension axis 41, while in one of the opposite staggered suspensions 34 there is a conic sleeve 42 into which falls the extensible cone 43 laid in the sliding sleeves 44 of the second opposite staggered suspension 34 and it is pushed by a spring 45 of the cone. The extensible cone 43 is removed from the engagement by a rod 46 controlled by a link 47 over a rock arm 48. The link 47 includes a guide bar 49 and it is conducted in a guide body 50 that is connected through the arm 51 with a motion sleeve 59.

An essential part of the side linear drive 35 is a reversible motion screw 52 laid in the central part 28 in the fixation block 53 in the radiaxial bearing 54 and radial bearing 55. The reversible motion screw 52 is driven by one-grade transmission 56 located between the bearings and driven by rotational drive 57, attached by flange also in the fixation block 53. In each of the opposite motion threads there is screwed on a motion nut 58 with a respective thread, while each of them is laid in the motion sleeve 59. Each motion sleeve 59 is on the side firmly connected with the form slider 60 laid in a guide 61, and the front part of the motion sleeve 59 is firmly connected with the guide sleeve 62, ended with a firmly connected shoulder 63. On this assembly there is placed the guide sleeve 64 with an end double shoulder. Between one and the other shoulder 63 there is a pull spring laid in 65. The second shoulder of the guide sleeve 64 with the end double shoulder is used to support the screw shoulder 66 with a set screw screwed into it 67. Axially in this screw there is the end of the linear drive string 36, secured by two pressing screws 68.

While the reversible motion 29 of the sides is secured by springs 69 through the side strings 70. The spring 69 is always laid in a guide pipe 71 and pressed by a guide head 72 with shoulder that supports a adjusting nut 73 and set screw 73 in which there is axially laid end of the side string 70 and fixed by pressing screws 68.

Positioning of each of the edge of the central line 30 through staggered suspensions 34 is done by linear drives 74 of the central line.

In the arm rest 33 area on both sides 32 of the femoral line there is a socked holder 75 for control 76 that can be located also on the tipping board 77 located on the back side of the central part 28 of the head line 22.

The surface of all the parts of the modifiable area 4 covered by upholstery 78, while the upholstery 78 is reinforced on the outer edges 79 with a decline to the central part of the area for lying, furthermore even the central parts 28 are declined in the end region of the head line 22 towards inward of the modifiable area 4.

With the gluteal line 24, in the main central axis of the modifiable area 4, there is firmly connected the area attachment 80 that is through the linear conductors 81 of the extension connected with the pillar attachment 82 firmly tying the heads of one or two extensible telescopic pillars 83. In the pillar attachment 82 there is the rotational drive 84 of area extension in form filling into the shape ridge 85, that is part of the area attachment 80.

On the opposite side of the extensible telescopic pillars 83 there are their feet 86 including connecting components and serving for connection with the connecting area 21 of the mobile omnidirectional chassis 2.

Functions

The substance of the robotic mobile and modifiable bed 1 lies in the possible transformations of the positions including the option to adjust height and ability of omnidirectional motion when it is possible using the controlled adjusting of the convertible system 3 of the modifiable area 4 to reach a wide range of the required positions up to transforming the modifiable area 4 into a plane area.

The omnidirectional motion is allowed by he mobile omnidirectional chassis 2, its basis consists of a central frame 5 and in its upper part in front-back direction there are linear chassis conductors 6 with suspended an extensible frames 7 on them while in each of them there is laid through silent-blocks 8 a fixed axle 9, with its basic part—connecting part 10 in which there are rotational drives 11 of the wheels and ach of them is attached to the connecting part 10 by a flange. The omnidirectional wheels 12 form a part of the fixed axle 9.

In case of converting the modifiable area 4 into a plane position it is necessary to increase the fixed axle 9 perch in view of the stability. This is possible thanks to the linear motion 13 of the chassis extension, connecting two extensible frames 7, while positioning of the extensible frames 7 in their end positions are allowed by rubber stops of the 14 extensible frame. In the area of the extensible frames 7 there are located the control units 15 of the rotational drives 11 of the wheels.

The user friendly battery charger 16 is located in the bottom part of the central frame 5 in its central area and the batteries 17 are located on the side areas of this frame.

Other important details are the circumferential bumper features 18, while the side ones are firmly attached to the central frame 5 and the front-back ones are part of the extensible frames 7. Safety and esthetical covering consists of longitudinally and axially divided central cover 19 attached to the central frame 5 and two parts of the front cover 20 attached in the extensible frames 7.

In the central area of the central frame 5 there is the connection area 21 with features for connection to a suitable attachment, such as a modifiable area 4.

The wide range of possible positions of modifiable area 4 that enables a wide range of positions within the transition between two uttermost positions, i.e. the sitting position when the robotic mobile modifiable bed 1 has a shape of a chair and the horizontal position is allowed by its transverse and longitudinal division.

The modifiable area 4 consisting of the following basic features of frame sub-assembly transverse and at the same time refract lines:

head line 22, back line 23, gluteal line 24, femoral line 25, calf line 26 and plantar line 27. Each of these lines except the gluteal line 24 consists of the central part 28 and two sides 29, so in the longitudinal direction the modifiable area 4 may be divided to the central line 30 and two opposite longitudinal side lines 31. The gluteal line 24 consists only of the central part 28.

The neighboring mutually connected central parts 28 and sides 29 are axially and swingingly connected by the staggered suspensions 34, allowing modifying the shapes of the convertible system of the robotic mobile and modifiable bed 1. All the sides 29 except the sides 32 of the femoral line are collapsible downwards by approx. 180°, the sides 32 of the femoral line are collapsible upwards by 90° and their upper edge also forms an arm rest 33 on both sides.

The above mentioned motions with the modifiable area 4 as a basis are realized using the linear drives 35 of the sides through strings of the linear drive 36 via the divider roll 37, while the string of the linear drive runs in the eccentric groove 38 of the side 29. In view of the fact that all the sides 29 of the balanced modifiable area 4 are blocked by conic connections 40 that are controlled also by the respective side linear drive 35, the linear drive 35 of the sides opens them in the first phase of the motion and only in the second phase occurs the motion of the sides 29 through strings 36 of the linear drive anchored in the sides 29 always by their ending 39.

In view of the effort to decrease the controlling forces of collapsing the sides 29 as much as possible, it is necessary to block them in their operating position. This calls for using a conic connection 40.

The reversible motion of each sides 29 is secured by a spring 69 through the side string 70. The spring 69 is always laid in a guide pipe 71 and pressed by a guide head 72 with shoulder and in its axis there is a set screw 67 and adjusting nut 73 and in the axis of the set screw there is the end of the side string 70, fixed by pressing screws 68.

The mutual swinging motions within the central line 30 are secured by linear drives of the central line 74 through staggered suspensions 34. All the motions of the convertible system of the robotic mobile and modifiable bed 1 are controlled via the controller 76 with the option to program the sequence of some of the operations and realized automatically to make it easier.

The conic connections 40 are near the suspension axis 41 and their function is to accurately block the position of the sides 29 against the central parts 28 so that required modifiable area 4 is created. The conic connection 40 is realized by connecting one of the opposite staggered suspensions 34 where there is a conic sleeve 42, with the other opposite staggered suspension 34 that includes extensible cone 43 laid in the sliding sleeves 44, pushed by a spring 45 of the cone into the functional position. Opening the conic connection 40 is possible thanks to a rod 46 controlled by a rock arm 48 affected by the pressure from a link 47 where this link includes a guide bar 49 conducted in a guide body 50 and is tied with a motion sleeve 59 through the arm 51.

Opening the conic connections 40 and moving the sides 29 always in one of the transverse lines is realized using the side linear drive 35. The basis of this motion is a reversible motion screw 52 laid revolvingly in the fixation block 53 through a radiaxial bearing 54 and radial bearing 55, while it is driven by the rotational drive 57 attached by flange in the fixation block 53 and the reversible motion screw 52 is driven over one-grade transmission 56.

The necessary linear motion is created by the motion nuts 58 with a respective thread against the reversible motion screw 52 laid in the motion sleeve 59 which is on the side connected with a form slider 60 moving in a guide 61. The motion sleeve 59 is set by a guide sleeve 62 with a shoulder 63, while between it and the shoulder 63 of the guide sleeve 64 with an end double shoulder there is pull spring 65 laid in.

The second shoulder 63 of the guide sleeve 64 with the end double shoulder is used to support the screw 66 shoulder with a set screw 67 screwed into it axially and inside this screw there is the end of the linear drive string 36 secured by two pressing screws 68.

In the arm rest 33 area on both sides 32 of the femoral line there is a socked holder 75 into which a control 76 is located and thus it can be applied both on right and left side. The control 76 can be located also on the tipping board 77 located on the central part 28 of the head line 22 and thus the operator may control the convertible system of the robotic mobile and modifiable bed 1.

In case of a change of the modifiable area 4 from the horizontal position to the sitting position it is necessary to have this formation moved to the front. The above mentioned motion is possible using the linear conductors 81 of the extension located between the area attachment 80, firmly connected with the central parts 28 of the gluteal line 24 and the pillar attachment 82 connecting the heads of the extensible telescopic pillars 83. The mutual movement of the counterparts is realized by rotational drive of the area attachment 84 that is part of the pillar attachment 82, in form filling into the shape ridge 85 that is part of the area attachment 80.

The ability to adjust height is secured by one or more extensible telescopic pillars 83, ended in the bottom with feet 86 with connecting features suitable for connecting e.g. the mobile omnidirectional chassis 2 with connecting area 21, adjusted for connection with a required attachment.

From the user perspective all parts of the modifiable area 4 are covered by a suitable upholstery 78, while the upholstery 78 is on the outer edges 79 reinforced with a decline to the central part of the area for lying, furthermore even the central parts 28 are declined in the end regions of the head line 22 and plantar line 27 towards inward of the modifiable area 4, which also is a security measure preventing falling from the modifiable area 4.

### INDUSTRIAL USE

The robotic mobile modifiable bed is a universal robotic convertible system with a wide range of possible positions of the modifiable area that enables a wide range of positions within the transition between two uttermost positions, i.e. the sitting position when the robotic mobile modifiable bed has a shape of a chair and the horizontal position. Furthermore, the unit is height-adjustable with the possibility of omnidirectional motion, using both manual and remote control including the option of using the automated motions. Universality of the unit lies in a variability of different environments—it is designed both for a classical indoor environment and medical facilities and for outdoor environment.

The suggested transport universal robotic convertible system can be used for example for senior citizens, immobile persons or patients in therapeutic processes. Therefore, it is suitable for a systemic use in public health service.

### A LIST OF USED POSITIONS

1) robotic mobile modifiable bed
2) mobile omnidirectional chassis
3) convertible system
4) modifiable area
5) central frame
6) linear chassis conductors
7) extensible frame
8) silent-block
9) fixed axle
10) connecting part
11) wheel drive
12) omnidirectional wheel
13) linear drive of chassis extension
14) extensible frame stop
15) control unit
16) battery charger
17) battery
18) circumferential bumper features
19) central cover
20) front cover
21) connection area
22) head line
23) back line
24) gluteal line
25) femoral line
26) calf line
27) plantar line
28) central part
29) side
30) central line
31) longitudinal side line
32) side of femoral line
33) arm rest
34) staggered suspension
35) drive of the sides
36) string of the drive
37) divider roll
38) eccentric groove
39) ending
40) conic connection
41) suspension axis
42) conic sleeve
43) extensible cone
44) sliding sleeve
45) cone spring
46) connecting rod
47) link
48) rock arm
49) guide bar
50) guide body
51) arm
52) reversible motion screw
53) fixation block
54) radiaxial bearing
55) radial bearing
56) one-grade transmission
57) rotational drive
58) motion nut
59) motion sleeve
60) form slider
61) guide
62) guide sleeve
63) shoulder
64) guide sleeve with an end double shoulder
65) pull spring
66) screw shoulder
67) set screw
68) pressure screw
69) spring
70) side string
71) guide pipe
72) guide head with shoulder
73) adjusting nut
74) linear drives of the central line
75) socked holder
76) control
77) tipping board
78) upholstery
79) outer edge
80) area attachment
81) linear extension conductor
82) pillar attachment
83) extensible telescopic pillar
84) rotational drive of area attachment
85) shape ridge
86) foot

1. The mobile omnidirectional chassis (2) characteristic by the following:
contains a central immobile* frame (5) and in its upper part there are four linear chassis conductors (6) and on each couple of these linear chassis conductors (6) in front-back direction there is suspended an extensible frame (7), while in each of them there is laid through silent-blocks (8) a fixed axle (9), consisting se of a connecting part (10) and omnidirectional wheels (12) while in the connecting part (10) there are the drives (11) of the omnidirectional wheels (12),
while the front and back extensible frames (7) are connected by a linear drive (13) of the chassis extension and the end position of both extensible frames (7) are limited by extensible frame stops (14), while in the extensible frames (7) there are located the control units (15) of the wheel rotational drives (11) and furthermore in the longitudinal axis of the central immobile frame (5), in the lower part there is the place for a battery charger (16), and along sides there are the batteries (17),
while the mobile omnidirectional chassis (2) is equipped with circumferential bumper features (18), while the circumferential bumper features (18) are firmly attached to the central frame (5) and the front-back circumferential bumper features (18) are part of the extensible frames (7),
while the mobile omnidirectional chassis (2) is equipped longitudinally and axially with a divided central cover (19) attached to the central frame (5) and front covers (20) attached in the extensible frames (7),
while in axial and lower part of the central frame (5) there is the connection area (21) with features for linking to a necessary type of the utility extension of the mobile omnidirectional chassis (2).

2. The robotic mobile modifiable bed (1) consisting of a mobile omnidirectional chassis (2) according to the requirement 1 and modifiable area (4) equipped with a
convertible system (3) that allows its controlled converting, characteristic by the following:
the modifiable area (4) consists of basic features of frame sub-assembly transverse and at the same time refract lines, that is head line (22), back line (23), gluteal line (24), femoral line (25), calf line (26) and plantar line (27) where each of the lines (22, 23, 25, 26 and 27) consists of the central part (28) and two sides (29), while all the central parts (28) make in the longitudinal direction refract central line (30) and all the sides (29) make two longitudinal side lines (31), while the gluteal line (24) consists only of the central part (28),
while the mutually connected central parts (28) and sides (29) are axially and swingingly connected, while the positioning of the opposite sides (29) and blocking the sides (29) in the plane position is controlled by the drive (35) of the sides, while positioning of each of the edge of the central line (30) is done by linear drives (74) of the central line,
while with the gluteal line (24), in the main central axis of the modifiable area (4), there is firmly connected the area attachment (80) that is through the linear conductors (81) of the extension connected with the pillar attachment (82),
while between the modifiable area (4) and mobile omnidirectional chassis (2) there is an interface, whose connecting features fall into the connecting area (21) of the mobile omnidirectional chassis (2).

3. The robotic mobile modifiable bed (1) according to the requirement 2 characteristic by the following:
the drive of the sides (35) is linear.

4. The robotic mobile modifiable bed (1) according to the requirement 2 characteristic by the following:
the central parts (28) and sides (29) are axially and swingingly connected by the staggered suspensions (34), while the staggered suspensions (34) of the central parts (28) and the sides (29) are firmly connected and the opposite parts are axially tied by the suspension axis (41),

5. The robotic mobile modifiable bed (1) according to the requirement 2 characteristic by the following:
part of the sides (29) are the sides (32) of the femoral line that in the upper position serve also as an arm rest (33)

6. The robotic mobile modifiable bed (1) according to the requirement 2 characteristic by the following:
the positioning of the opposite sides (29) is controlled always by one side linear drive (35) through strings of the linear drive (36) via the divider roll (37), while the string (36) of the drive runs in the eccentric groove (38) of the side and it is anchored in the side (29) by its ending (39), while the sides (29) are in the plane position always blocked by one or two conic connections (40) that are controlled also by the respective side drive (35).
while the conic connection (40) is laid eccentrically from the suspension axis (41), while in one of the opposite staggered suspensions (34) there is a conic sleeve (42) into which falls the extensible cone (43) laid in the sliding sleeves (44) of the second opposite staggered suspension (34) and it is pushed by a spring (45) of the cone,
while the extensible cone (43) is connected by a reject rod (46) controlled by a link (47) over a rock arm (48) where this link (47) includes a guide bar (49) and it is conducted in a guide body (50) that is connected through the arm (51) with a motion sleeve (59),
while another part of the side drive (35) is a reversible motion screw (52) laid in the central part (28) in the fixation block (53) in the radiaxial bearing (54) and radial bearing (55) where the reversible motion screw (52) is over one-grade transmission (56) located between the bearings and driven by rotational drive (57), attached by flange also in the fixation block (53),
while in each of the opposite motion threads there is screwed on a motion nut (58) with a respective thread, while each of them is laid in the motion sleeve (59), where each motion sleeve (59) is on the side firmly connected with the form slider (60) laid in a guide (61), and the front part of the motion sleeve (59) is firmly connected with the guide sleeve (62), ended with a firmly connected shoulder (63),
while on this assembly there is placed the guide sleeve (64) with an end double shoulder, while between one and the other shoulder (63) there is a pull spring (65) laid in, where the second shoulder of the guide sleeve with the end double shoulder (64) is used to support the screw shoulder (66) with a set screw (67) screwed into it,
while axially in this screw (67) there is the end of the linear drive string (36), secured by two pressing screws (68),
while the reversible motion of the sides (29) is secured by springs (69) through the side strings (70) where the spring (69) is always laid in a guide pipe (71) and pressed by a guide head (72) with shoulder that supports a adjusting nut (73) and set screw (67) in which there is axially laid end of the side string (70) and fixed by pressing screws (68).

7. The robotic mobile modifiable bed (1) according to the requirement 2 characteristic by the following:
the pillar attachment (82) is firmly tying the heads of the extensible telescopic pillars (83) where in the pillar attachment (82) there is the rotational drive (84) of area attachment in form filling into the shape ridge (85), that is part of the area attachment (80), while on the opposite side of the extensible telescopic pillars (83) there are their feet (86) including connecting components and serving for connection with the connecting area (21) of the mobile omnidirectional chassis (2).

8. The robotic mobile modifiable bed (1) according to the requirement 2 characteristic by the following:
the surface of all the parts of the modifiable area (4) covered by upholstery (78), while the upholstery (78) is reinforced on the outer edges (79) with a decline to the central part of the area for lying, furthermore even the central parts (28) are declined in the end region of the head line (22) and plantar line (27) towards inward of the modifiable area (4).

9. The robotic mobile modifiable bed (1) according to the requirement 2 characteristic by the following:
on the modifiable area (4) there is a socked holder (75) for control (76).

10. (canceled)

11. (canceled)
